(19) United States
(12) Patent Application Publication
(10) Pub. No.: US 2013/0111149 A1
(43) Pub. Date: May 2, 2013

(54) INTEGRATED CIRCUITS WITH CACHE-COHERENCY

(71) Applicant: Arteris SAS, Guyancourt (FR)

(72) Inventors: Laurent Rene Moll, San Jose, CA (US); Jean-Jacques Lecler, Sunnyvale, CA (US)

(73) Assignee: Arteris SAS, Guyancourt (FR)

(21) Appl. No.: 13/659,850

(22) Filed: Oct. 24, 2012

Related U.S. Application Data
(60) Provisional application No. 61/551,922, filed on Oct. 26, 2011.

(51) Int. Cl. G06F 12/08

(52) U.S. Cl. 711/141; 711/E12.026

(57) ABSTRACT

An improved cache coherency controller, method of operation, and system of such is provided. Traffic from coherent agents to shared targets can flow on different channels through the coherency controller. This improves quality of service for performance sensitive agents. Furthermore, data transfer is performed on a separate network from coherency control. This minimizes the distance of data movement, reducing congestion for the physical routing of wires on the chip and reduces the power consumption for data transfers.

### CROSS-REFERENCE TO RELATED APPLICATIONS

This application claims priority under 35 USC 119 from U.S. Provisional Application Ser. No. 61/551,922 filed on Oct. 26, 2011, titled INTEGRATED CIRCUITS WITH CACHE-COHERENCY by inventors Laurent Moll and Jean-Jacques Lecler, the entire disclosure of which is incorporated herein by reference.

### FIELD OF THE INVENTION

This disclosure is related generally to the field of semiconductor chips and more specifically to systems on chip with cache coherent agents.

### BACKGROUND

Cache coherency is used to maintain the consistency of data in a distributed shared memory system. A number of agents, each usually comprising one or more caches, are connected together through a central cache coherency controller. This allows the agents to take advantage of the performance benefit of caches while still providing a consistent view of data across agents.

A number of cache coherency protocols exist, such as the Intel Pentium Front Side Bus protocol (FSB), Intel Quick Path Interconnect (QPI), ARM AXI Coherency Extensions (ACE) or Open Core Protocol (OCP) version 3. Cache coherency protocols are usually based on acquiring and relinquishing permissions on sets of data, typically called cache lines containing a fixed amount of data (e.g. 32 or 64 bytes). Typical permissions are:
None: the cache line is not in the agent and the agent has no permission to read or write the data.
Readable: the cache line is in the agent and the agent has permission to read the cache line content stored locally. Multiple agents can simultaneously have read permission on a cache line (i.e. multiple readers).
Readable and writable: the cache line is in the agent and the agent has permission to write (and typically read) the cache line content. Only one agent can have write permission on a cache line, and no agent can have read permission at the same time.

There is usually a backing store for all cache lines (e.g. a DRAM). The backing store is the location where the data is stored when it is not in any of the caches. At any point in time, the data in the backing store may not be up to date with respect of the latest copy of a cache line which may be in an agent. Because of this, cache lines inside agents often includes an indication of whether the cache line is clean (i.e. it has the same value as in the backing store) or dirty (i.e. it needs to be written back to the backing store at some point as it is the most up-to-date version). Targets on the interconnect serve as backing stores for groups of the address map. When, after a coherent request, it is determined that the backing store must be queried or updated, reads or writes are sent to the appropriate target, based on the address.

The permission and “dirtiness” of a cache line in an agent is referred to as the “state” of the cache line. The most common set of coherency states is called MESI (Modified-Exclusive-Shared-Invalid), where Shared corresponds to the read permission (and the cache line being clean) and both Modified and Exclusive give read/write permissions, but in the Exclusive state, the line is clean, while in the Modified state, the line is dirty and must be eventually written back. In that state set, shared cache lines are always clean.

There are more complex versions like MOESI (Modified-Owned-Exclusive-Shared-Invalid) where cache lines with read permission are allowed to be dirty.

Other protocols may have separate read and write permissions. Many cache coherency state sets and protocols exist.

In the general case, when an agent needs a permission on a cache line that it does not have, it must interact with other agents directly or through a cache coherency controller to acquire the permission. In the simplest “snoop-based” protocols, the other agents must be “snooped” to make sure that the permission requested by the agent is consistent with the permissions already owned by the other agents. For instance, if an agent requests read permission and no other agent has write permission, the read permission can be granted. However, if an agent already has write permission, that permission must be removed from that agent first before it is granted to the initiating agent.

In some systems, the agent directly places snoop requests on a bus and all agents (or at least all other agents) respond to the snoop requests. In other systems, the agent places a permission request to a coherency controller, which in turn will snoop the other agents (and possibly the agent itself).

In directory-based protocols, directories of permissions acquired by agents are maintained and snoops are sent only when permissions need to change in an agent.

Snoop filters may also be used to reduce the number of snoops sent to agents. Snoop filters keep a coarse view of the content of the agents and don't send a snoop to an agent if it knows that agent does not need to change its permissions.

Data and permissions interact in cache coherency protocols, but the way they interact varies. Agents usually place requests for both permission and data simultaneously, but not always. For instance, an agent that wants to place data in its cache for reading purposes and has neither the data nor the permission can place a read request including both the request for permission and for the data itself. However, an agent that already has the data and read permission but needs write permission may place an “upgrade” request to write permission, but does not need data.

Likewise, responses to snoop requests can include an acknowledgement that the permission change has happen, but can also optionally contain data. The snooped agent may be sending the data as a courtesy. Alternatively, the snooped agent may be sending dirty data that has to be kept to be eventually written back to the backing store.

Agents can hold permission without data. For instance, an agent that wants to write a full cache line may not request data with the write permission, as it knows it will not use it (it will override it completely). In some systems, holding partial data is permitted (in sectors, per byte . . . ). This is useful to limit data transfers but it makes the cache coherency protocol more complex.

Many cache coherency protocols provide two related way for data to leave an agent. One is through the snoop response path, providing data as a response to a snoop. The other is a spontaneous write path (often called write back or evict path) where the agent can send the data out when it does not want to keep it anymore. In some protocols, the snoop response and write back paths are shared.

Fully coherent agents are capable of both owning permissions for cache lines and receiving snoop requests to check and possibly change their permissions, triggered by a request from another agent. The most common type of fully coherent agent is a microprocessor with a coherent cache. As the microprocessor needs to do reads and writes, it acquires the appropriate permissions and potentially data and puts them in its cache. Many modern microprocessors have multiple levels of caches inside. Many modern microprocessors contain multiple microprocessor cores, each with its own cache and often a shared second-level cache. Many other types of agents may be fully coherent such as DSPs, GPUs and various types of multimedia agents comprising a cache.

In contrast, I/O coherent (also called one-way coherent) agents do not use a coherent cache, but they need to operate on a consistent copy of the data with respect to the fully coherent agents. As a consequence, their read and write request may trigger coherency actions (snoops) to fully coherent agents. In most cases, this is done by having either a special bridge or the central coherency controller issue the appropriate coherency action and sequence the actual reads or writes to the backing store if necessary. In the case of a small bridge, that bridge may act as a fully coherent agent holding permissions for a small amount of time. In the case of the central coherency controller, it tracks the reads and writes, and prevents other agent from accessing cache lines that are being processed on behalf of the I/O coherent agent.

### STATE OF THE ART

Cache coherency controllers merge the request traffic from multiple coherent agents onto one channel to a particular backing store, so that all requests of a given type and address always go through the same channel to reach the backing store. This has two negative consequences.

First, quality of service on the requests may not be easy to preserve on the merged traffic. For instance, if one agent requires the lowest latency and another agent can use all the bandwidth, providing the lowest latency to the first agent will be difficult once their request traffic is merged. This is, for example, a problem for read requests of microprocessors when faced with high bandwidth traffic from agents like video and graphics controllers.

Second, a coherency controller is not generally located directly between high bandwidth coherent agents and their targets. Therefore, the forcing data transfers between coherent agents and targets to go through a coherency controller can substantially lengthen on-chip connections. This adds delay and power consumption and can create unwanted wire congestion. Although coherency control communication must occur between a coherency controller and distant coherent agents, data need not be forced to go through the coherency controller.

Therefore, what is needed is a cache coherency controller that provides flexibility in the path from coherent agents to targets, allowing traffic to select one of a multiplicity of channels to a given target. Further, the coherency controller can allow the coherent agents to have a direct datapath to the targets, bypassing the coherency controller entirely.

### SUMMARY

Coherency controllers and targets are components of a system connected through interfaces that communicate using protocols. Some common industry standard interfaces and protocols are: Advanced Microcontroller Bus Architecture (AMBA) Advanced eXtensible Interface (AXI), Open Core Protocol (OCP), and Peripheral Component Interface (PCI). The interfaces of the components can be directly connected to one another or connected through a link or an interconnect. A channel is a subset of an interface distinguished by a unique means of flow control. Different interface protocols comprise different numbers and types of channels. For instance, some protocols (like AXI) use different physical channels for reads and writes while others (like OCP) use the same channel for reads and writes. Channels may use separate physical connections or may share a physical connection that multiplexes unique flows of communication. Channels may communicate information of addresses, write data, read data, write responses, snoop requests, snoop responses, other communications, or a combination of types of information.

Cache coherency, as implemented in conventional integrated circuits, requires a tight coupling between processors, their main memories, and other agents. The coherency controller is a funnel through which the requests of all coherent agents to a given target are merged into a single stream of data accesses. To provide fast responses to a processor's requests requiring accesses of other processors' caches, it is important to have the coherency controller and all processors physically close to each other. On the two-dimensional surface of a semiconductor chip, for a coherency system to provide such high performance, the rectilinear regions of cache-coherent processors must be placed close to each other. It is difficult to make more than four rectangles meet at a point, and it is correspondingly difficult to scale conventional cache coherent systems much beyond four processors.

The herein disclosed invention recognizes that a coherency controller need not be a funnel. It can be a router with multiple channels, virtual or physical, enabled to send the same type of transaction to a given target. It is also recognized that, while data communication between coherent agents and a target must be controlled by the coherency controller, such data need not pass through the coherency controller. Separate networks-on-chip for coherency control and data transfer are beneficial.

The herein disclosed invention is directed to a means of providing data coherency. A coherency controller provides multiple channels enabled to send requests to a target. This provides for improved quality-of-service to coherent agents with different latency and throughput requirements.

Furthermore, the herein disclosed invention provides for the network for communication of coherency control information (snoops) to be partially separate from the datapath network. Some channels carry only snoops, some channels carry only data, and some channels carry both snoops and data. This untangling of data and control communication provides for an improved physical design of chips. That in turn requires less logic delay and lower power for data transfer.

### BRIEF DESCRIPTION OF THE DRAWINGS

FIG. 1 shows a system of coherent agents, a target, and a coherency controller in accordance with the prior art.

FIG. 2 shows a system with multiple channels within the coherency controller enabled to send requests to the target in accordance with an aspect of the present invention.

FIG. 3 shows a system with a dedicated end-to-end request path in accordance with an aspect of the present invention.

FIG. 4 shows a system with a separate coherency interconnect in accordance with an aspect of the present invention.

FIG. 5 shows a coherent system of microprocessor cores and I/O agents with a target in accordance with the prior art.

FIG. 6 shows a system with separate data and coherency control channels in accordance with an aspect of the present invention.

### DETAILED DESCRIPTION

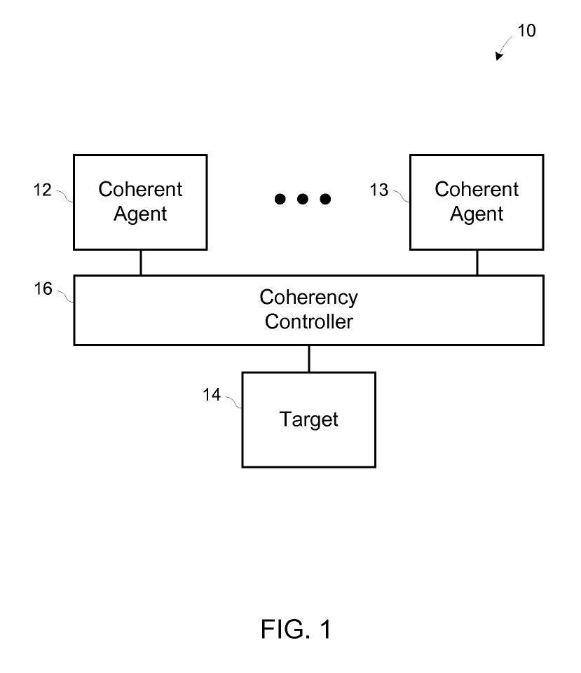

Referring now to FIG. 1, in a cache coherent system 10, at least two coherent agents 12 and 13 maintain a coherent view of the data available in system 10 by exchanging messages. These messages for instance make sure that no agent is trying to use the value of a piece of data while it is being written. This is especially needed when agents are allowed to cache data in internal memories.

The data being kept coherent is normally stored in at least one target 14. Targets of coherent requests are typically DRAM or SRAM, which act as backing stores. The coherency protocol keeps track of the current value of any data, which may be located in a coherent agent, the backing store, or both. When a piece of data is not up to date in the backing store, the coherency protocol makes sure the current value is written back to the backing store at some point (unless specifically asked not to).

The interconnection between coherent agents 12 and 13 may take many forms. In many cases, agents 12 and 13 are connected to a coherency controller 16 (e.g. ARM's Cache Coherent Interconnect) that is connected to the target as shown on FIG. 1. In some other cases, the agents 12 and 13 are all connected through a bus and the target also has a connection to the bus (e.g. Intel's Front Side Bus).

Because latency is most important for microprocessor cores, most cache coherency mechanisms are heavily optimized to keep latencies to the microprocessors low, and are typically physically located close to the microprocessor cores. Other agents that need full or I/O coherency, but may support higher latencies may be located further.

Because existing cache coherency protocols handle both the state and the data, these further agents must have all data passing through this coherency controller 16, physically located near the microprocessor cores. This means that all data exchanges between the agents 12 and 13 and the target 14 go through the coherency controller, typically creating wire congestion and potentially performance bottlenecks, often near the microprocessor cores, where it is the most expensive and difficult to solve. This also creates unnecessary travel in the integrated circuit, especially if some of the coherent agents 12 and 13 are close to the target 14. This extra travel can also increase the power of the integrated circuit. In addition, the coherency controller 16 may not have the internal bandwidth to serve the full amount of requested data, creating a performance bottleneck. Finally, in some cases, some of the coherent agents 12 and 13 may need to be shut down, but the coherency controller 16 may not, as it serves as the unique point of access to the targets 14.

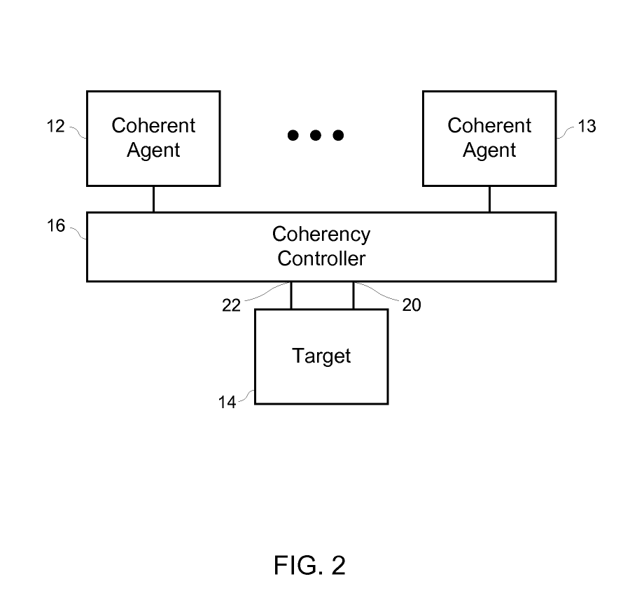

FIG. 2 shows an improved system according to one aspect of this invention. Coherent agents 12 and 13 are connected through coherency controller 16 to at least one target 14. The coherency controller has at least two channels 20 and 22 enabled to send requests to the same target or set of targets. In some embodiments, the two channels 20 and 22 are two separate physical channels. In other embodiments, they are virtual channels layered on top of a single physical connection. At least some requests can be sent on either channel 20 or 22 and coherency controller 14 may select the channel on which to send a request based on a number of parameters. According to some aspects of the invention, the selection is made based solely on which interface the initiating request came from. According to some aspects of the invention, the selection is based on the identity of the initiating agent. According to other aspects of the invention, the selection is based on the address of the request. According to other aspects of the invention, the selection is based on the type of request (e.g. read/write). According to yet other aspects of the invention, the selection is based on the priority of the request. According to some aspects of the invention, the selection is based on sideband information passed by the initiating agent. According to some aspects of the invention, the selection is based on configuration signals or registers. According to some aspects of the invention, the selection is based on a combination of the interface from which the initiating request came, the initiating agent, the type of request, the priority of the request, sideband information and configuration signals or registers. According to other aspects of the invention, the selection is based on a combination of the address of the request and at least one of: the interface the initiating request came from, the initiating agent, the type of request, the priority of the request, sideband information and configuration signals or registers. According to some aspects of the invention, the reads on behalf of one or more agents are sent to one channel and all other traffic on another.

According to some aspects of the invention, all coherent agents 12 and 13 are fully coherent. According to other aspects of the invention, some of the coherent agents 12 and 13 are I/O coherent and the other are fully coherent.

According to some aspects of the invention, when the selection is based on static parameters (e.g. interface of the initiating request or read vs. writes if those are on separate channels on the coherent agent interfaces), separate paths are provided inside the coherency controller 16 between the agent interfaces and the target channels. While coherency has to be kept between the requests traveling on the different paths from agent interface to target channel, this does not require the requests to be merged into a single queue. This arrangement allows for independent QoS and bandwidth management on the paths between the coherent agent interfaces and the target channels and by extension between the coherent agents and the target.

According to some aspects of the invention, channels 20 and 22 only carry reads while writes are carried separately. According to other aspects of the inventions, channels 20 and 22 carry reads, and channel 20 also carries some or all writes destined for the target. According to other aspects of the invention, channels 20 and 22 carry reads and writes, and the selection criteria for reads and writes can be different.

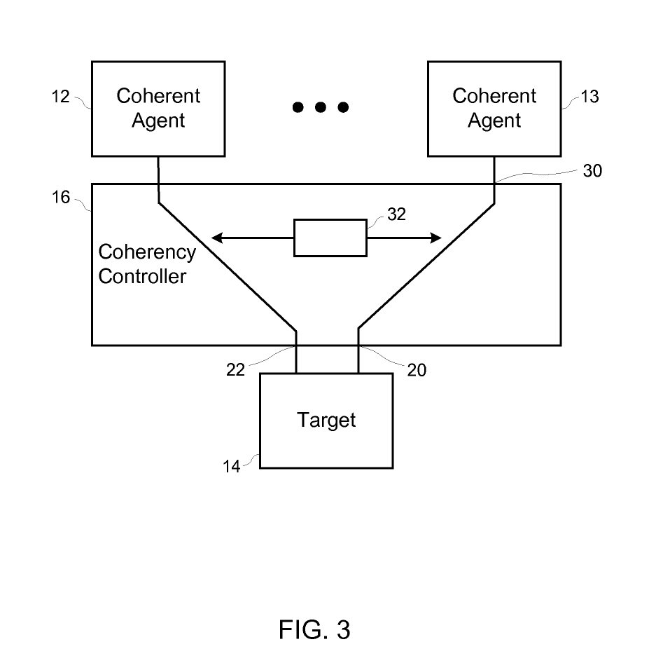

FIG. 3 shows such an arrangement. Coherent agents 12 and 13 are connected to coherency controller 16. Interface 30 connected to coherent agent 13 has a direct path to channel 20 for reads, while the read traffic from coherent agent 12 has a direct path to channel 22. Logic 32 is used to cross-check the traffic destined to different target channels to guarantee that no coherency requirement is being violated. In the general case, that logic will let traffic on the path from agent interface 30 to target channel 20 go independently from the rest of the traffic.

According to some aspects of the invention, coherent agent 13 is a microprocessor and needs the lowest latency on its read path. According to some aspects of the invention, coherent agent 12 is an I/O coherent agent and the aggregate traffic of a number of coherent agents.

According to some aspects of the invention, the write traffic from coherent agents 12 and 13 is merged and sent to the target separately from channels 20 and 22.

According to other aspects of the invention, the write traffic from coherent agents 12 and 13 is merged and sent to the target on channel 22.

According to other aspects of the invention, the write traffic from coherent agents 12 and 13 is kept separate and sent separately from channels 20 and 22.

According to other aspects of the invention, the write traffic from coherent agent 12 is sent on channel 22 and the write traffic from coherent agent 13 is sent on channel 20.

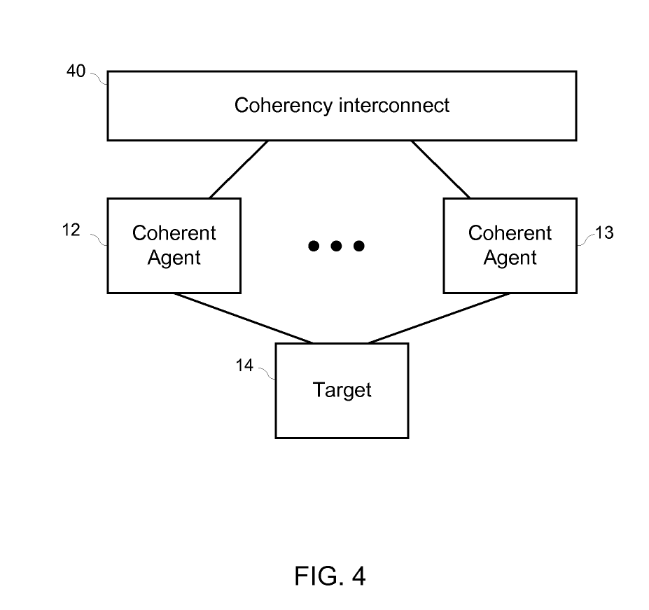

Referring now to FIG. 4, a system is shown according to an aspect of the present invention. At least two coherent agents 12 and 13 are connected to each other through a coherency interconnect 40. Each of the coherent agents 12 and 13 is also interconnected to at least one target 14. In some embodiments, coherency interconnect 40 is just an interconnect fabric. In other embodiments, coherency interconnect 40 contains one or more coherency controllers. In some embodiments, some of the agents may be themselves coherency controllers connecting other agents. Because the coherent agents 12 and 13 have direct connections to the target 14, data does not need to travel unnecessarily. As a consequence, wire congestion is reduced, power is reduced, and performance bottlenecks are removed.

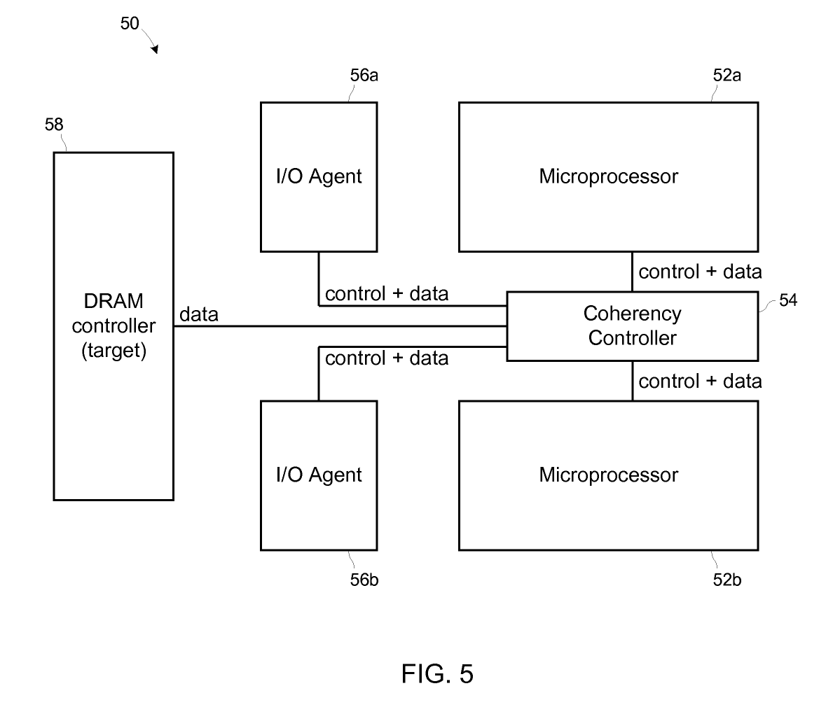

FIG. 5 shows a specific embodiment of a system 50 according to the prior art. Two microprocessors 52a and 52b are connected to a coherence controller 54. The connection between microprocessors 52a and 52b and coherency controller 54 are used to resolve data state coherency and to carry the related data traffic. When data must be read from or written to a target 58, coherency controller 54 does so on behalf of microprocessor 52a or 52b. Two I/O agents 56a and 56b are also directly connected to the coherency controller 54 for the purpose of resolving data state coherency and carrying the related data traffic. While they are located near target 58, any read from or write to the target must be done through the coherency controller 54.

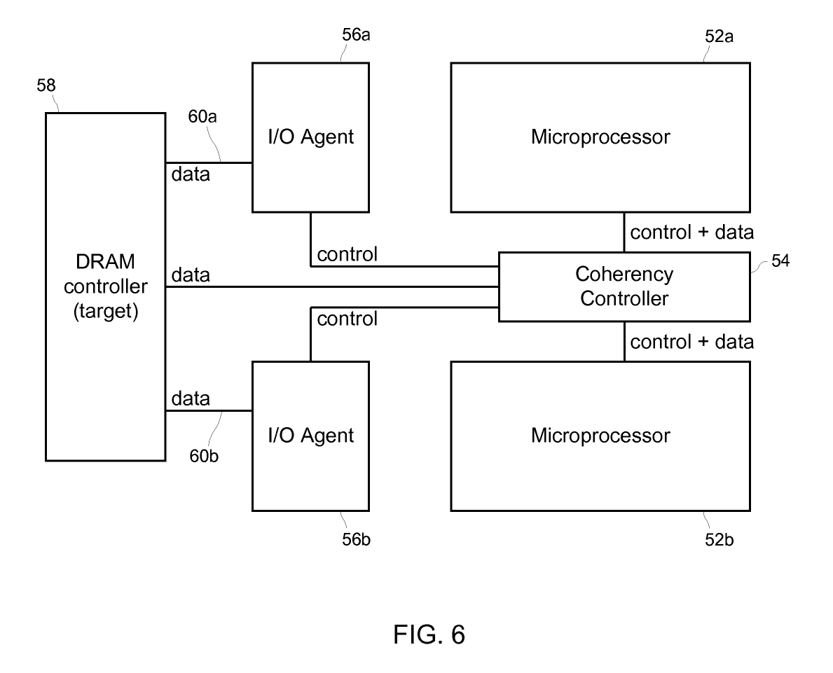

Referring now to FIG. 6, in accordance with the teachings of the present invention, the system of FIG. 5 is modified by adding data connection 60a between I/O agent 56a and target 58 and by adding data connection 60b between I/O agent 56b and target 58. The distance travelled by data transferred between I/O agents and the target is much smaller than in FIG. 5. Coherency controller 54 and its connections to agents effectively compose a coherency network. I/O agents 56a and 56b still use the coherency network to resolve data state coherency, but the data transfer portion is done directly with the target 58. In some embodiments, the cache coherency protocol may still carry data in specific cases. For example, in accordance with the embodiment of FIG. 6, when the data is directly available from microprocessor 52a, the cache coherency network carries data. In some other embodiments there is no data being carried on the coherency network and all data transfers are directly done with target 58.

If the I/O agents 56a and 56b were non coherent in the system described in FIG. 5 (where the “exclusive control link” did not exist), they could be made coherent without changing the path used to connect them to the target. Instead, the only thing that must be added is the coherency network (“control” link), which is usually substantially smaller in the number of wires.

In accordance with various aspects of the present invention, at least one of the describe components, such as the initiator or the target, is an article of manufacture. Examples of the article of manufacture include: a server, a mainframe computer, a mobile telephone, a personal digital assistant, a personal computer, a laptop, a set-top box, an MP3 player, an email enabled device, a tablet computer, a web enabled device having one or more processors, or other special purpose computer (e.g., a Central Processing Unit, a Graphical Processing Unit, or a microprocessor) that is configured to execute an algorithm (e.g., a computer readable program or software) to receive data, transmit data, store data, or performing methods. By way of example, the initiator and/or the target are each a part of a computing device that includes a processor that executes computer readable program code encoded on a non-transitory computer readable medium to perform one or more steps.

It is to be understood that this invention is not limited to particular embodiments or aspects described, as such may vary. It is also to be understood that the terminology used herein is for the purpose of describing particular embodiments only, and is not intended to be limiting, since the scope of the present invention will be limited only by the appended claims.

Where a range of values is provided, such as the number of channels or the number of chips or the number of modules, it is understood that each intervening value, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Any methods and materials similar or equivalent to those described herein can also be used in the practice or testing of the present invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A coherency controller comprising:
a plurality of coherent agent interfaces enabled to be connected to coherent agents; and
a plurality of target channels enabled to be connected to a target,
wherein the coherency controller can choose between the channels to send a request to the target.

2. The coherency controller of claim 1 wherein the plurality of target channels are virtual channels.

3. The coherency controller of claim 1 wherein the plurality of target channels are physically separate.

4. The coherency controller of claim 1 wherein the coherency controller chooses the channel on which to send a request based on the interface from which the originating request came.

5. The coherency controller of claim 1 wherein the coherency controller chooses the channel on which to send a request based on the type of the request.

6. The coherency controller of claim 1 wherein the coherency controller chooses the channel on which to send a request based on a priority of the request.

7. The coherency controller of claim 1 wherein the coherency controller chooses the channel on which to send a request based on a signal to the coherency controller.

8. The coherency controller of claim 1 wherein the coherency controller chooses the channel on which to send a request based on the address of the request.

9. The coherency controller of claim 1 wherein the coherency controller chooses the channel on which to send a request based on which coherent agent initiated the request.

10. The coherency controller of claim 1 wherein the coherency controller chooses the channel on which to send a request based on sideband information passed by the initiating agent.

11. The coherency controller of claim 1 wherein the coherency controller chooses the channel on which to send a request based on a combination of criteria, wherein the criteria are selected from a set including the interface the originating request came from, the address of the request, the initiating agent, the type of request, a priority of the request, sideband information, and a signal to the coherency controller.

12. The coherency controller of claim 1 wherein the at least one agent interface is enabled to connect to an I/O coherent agent.

13. The coherency controller of claim 1 wherein the at least one agent interface is enabled to connect to a fully coherent agent.

14. The coherency controller of claim 13 wherein the fully coherent agent is a microprocessor.

15. The coherency controller of claim 1 wherein the reads requested on behalf of at least one agent are sent to a first channel and reads requested on behalf of at least one other agent are sent to a second channel.

16. The coherency controller of claim 15 wherein the paths for the reads to the first channel and for the reads to the second channel are separate.

17. A system comprising:
a plurality of coherent agents;
a coherency network through which the coherent agents exchange messages to maintain coherency; and
at least one target that stores data,
wherein a coherent agent is operably connected directly to the target to transfer data, thereby avoiding sending data through the coherency network.

18. The system of claim 17 further comprising a datapath network through which the coherent agent is connected to the target to transfer data.

19. The system of claim 17 where data is exchanged directly between the plurality of coherent agents and the target.

20. The system of claim 17 wherein at least one of the plurality of coherent agents is a coherency controller and operatively connected to an other coherent agent to maintain coherency between the plurality of coherent agents and the other coherent agent.

21. The system of claim 17 wherein at least one of the plurality of coherent agents is a coherency controller operatively connected to at least one I/O coherent agent to maintain I/O coherency between the plurality of coherent agents and the at least one I/O coherent agent.

22. The system of claim 17 wherein the plurality of coherent agents are connected directly to each other.

23. The system of claim 17 wherein the plurality of coherent agents are connected to each other using an interconnection fabric.

24. The system of claim 17 wherein the plurality of coherent agents are connected through at least one coherency controller.

25. A method for accessing data stored in a target within a cache coherent system comprising, the method comprising the steps of:
requesting appropriate ownership of the data for the type of desired access;
directly accessing the data from the target that serves as a data backing store; and
relinquishing ownership of the data.
